(19) United States
(12) Patent Application Publication
(10) Pub. No.: US 2005/0269517 A1
(43) Pub. Date: Dec. 8, 2005

(54) DC voltage supply to RF electrode systems

(75) Inventors: Gerhard Weiss, Weyhe (DE); Gerhard Heinen, Grasberg (DE)

Correspondence Address: KUDIRKA & JOBSE, LLP, ONE STATE STREET, SUITE 800, BOSTON, MA, 02109, US

(73) Assignee: BRUKER DALTONIK GMBH, Bremen (DE)

(21) Appl. No.: 11/086,994

(22) Filed: Mar. 22, 2005

(30) Foreign Application Priority Data
Mar. 25, 2004 (DE) 10 2004 014 583.0

(51) Int. Cl. H01J 3/14

(52) U.S. Cl. 250/396 R

(57) ABSTRACT

The invention relates to ion-optical RF-operated electrode systems such as ion guide systems, ion fragmentation systems, ion filtering systems or ion storage systems which require additional DC potential gradients by means of DC voltages on resistance systems. The invention consists in supplying the DC voltages via center taps between several separate secondary windings of an RF transformer generating the RF voltage.

### FIELD OF THE INVENTION

The invention relates to ion-optical RF-operated electrode systems such as ion guide systems, ion fragmentation systems, ion filtering systems or ion storage systems which require additional DC potential gradients by means of DC voltages applied to resistance systems.

### BACKGROUND OF THE INVENTION

A plurality of means for manipulating ions in a vacuum are now known, in particular quadrupole mass filters, ion guide systems, collision cells for fragmenting ions and ion collection systems such as ion funnels. These systems usually make use of the fact that ions of both polarities are repelled by strongly inhomogeneous radio frequency (RF) fields in the vicinity of electrodes. In such cases, one speaks of a pseudopotential of these inhomogeneous RF fields. Inhomogeneous RF fields can be generated by applying RF voltages to tips oriented perpendicularly to a surface, or to wires or rods arranged in parallel, as described in patent specification U.S. Pat. No. 5,572,035 (J. Franzen). There are systems of parallel rods (so-called “multipole systems”), of coiled wires (for example double helix) or of parallel rings with cylindrical or conical interior. The famous quadrupole system comprising cylindrical or hyperbolic longitudinal electrodes, invented by Wolfgang Paul and Helmut Steinwedel some 50 years ago (DE 944 900), is but one example of such a system. In the following, the term “electrode systems” or “ion-optical electrode systems” will be used for the sake of simplicity when no specialized designation can be used, on the tacit understanding that the electrode systems are somehow charged with a radio frequency (RF) voltage.

In many cases, it is desired not simply to confine the ions in an electrode system of this type, as if in a virtual tube or funnel, but also to direct them against resistances, for example against the decelerating or damping effect of a relatively high gas pressure. This requires a DC potential gradient to be superimposed onto the usually elongated electrode system in the longitudinal direction, thereby driving the ions to one end of the system. The generation of a potential gradient requires that, somehow, at least two DC potentials which are independent of the RF voltage be supplied to the electrode system; these DC potentials usually generate the potential gradient as a voltage drop by means of a chain of resistors or of a resistance layer. Since the RF voltage can be a few megahertz and a few kilovolts, the generator for the DC potentials must be well protected by chokes which are intended to prevent the RF voltage penetrating into the DC generator. The RF generator, usually the secondary winding of a transformer, must also be protected from the DC voltage applied by means of resistors and capacitors.

We here list a few examples of electrode systems to which DC voltages can be applied to transmit ions.

The simplest way of doing this is to use a quadrupole electrode system made of four thin resistance wires, across each of which the DC voltage drop is generated. But the thin wires require a really high RF voltage in order to generate the quadrupole RF field, since the largest voltage drop occurs in the immediate vicinity of the thin wire. Moreover, the resistance must not be particularly high because, otherwise, the RF voltage cannot propagate quickly enough along the wires. It is therefore only possible to generate extremely small DC voltage drops along the wire.

For quadrupole systems with hyberbolic surfaces, a large number of clamped parallel wires can be used to replicate the four hyperbolic surfaces of the quadrupole system. Quadrupole systems of this type replicated out of wires were already in use some 40 years ago by Wolfgang Paul and his coworkers. Resistive wires can be used to generate a voltage drop.

Other systems which have an electrically generated forward drive are known from U.S. Pat. No. 5,572,035 (J. Franzen). One subject of the patent covers ion guide systems which are completely different to the rod or wire systems known before. One of these ion guide systems consists of only two helical, coiled conductors in the shape of a double helix, operated by the two phases of an RF voltage. Another consists of coaxial rings to which the phases of an RF AC voltage are alternately connected. Both systems can be operated so that an axial feed of the ions is generated. The double helix may be produced from resistance wire across which a DC voltage drop is generated, in a similar way to the quadrupole rod system made of thin wires; since the double helix is more compatible with thinner wires, however, and also has longer wires, it is more suitable for the DC voltage drop. The individual rings of the ring system can be supplied with a DC potential which decreases in steps ring by ring, as also described in the patent. This decreasing DC voltage system is formed by means of two chains of resistors from one ring to the next-but-one ring in each case, while the RF is transmitted via two chains of capacitors from one ring to the next-but-one ring.

Similarly, ion funnels can be constructed of rings (U.S. Pat. No. 6,107,628, R. D. Smith, S. A. Shaffer) having a conically tapering interior in which the ions are intended to be driven against the repelling pseudoforce to the tapering output.

Further solutions for ion manipulators which allow the ions to be driven along the axis in the interior of the system by means of a superimposed DC voltage drop are described in U.S. Pat. No. 5,847,386 (B. A. Thomson and C. L. Jolliffe):
A quadrupole rod system whose nonconducting rods possess an externally applied resistance layer across which a voltage drop is generated (better than the quadrupole system made of thin resistance wires);
A quadrupole rod system made of nonconducting thin-walled tubes, having a high-resistance layer on the outside for a DC voltage drop and a metal layer on the inside for the RF supply which is intended to act to the outside through the insulator and the high-resistance layer. The DC voltage in this case is supplied via chokes, with no connection to the RF source except via the capacitive bonding of the resistance layer to the metallic layer.

The supply of the DC voltage via chokes at the “hot” end of the RF transformer is unsatisfactory, however, not least because effective chokes always possess a higher ohmic resistance as well.

### SUMMARY OF THE INVENTION

The invention consists in generating at least two DC potentials for potential gradients on chains of resistors, resistance layers or individual diaphragms along an RF-operated ion-optical electrode system with a transformer which has at least two secondary windings with center taps, so that the DC potentials across the center taps can be fed in between two secondary windings. The two secondary windings then have, at two ends, the same phase of the RF voltage but different DC potentials. If the windings are as identical as possible, they also have the same amplitudes of the RF voltages. The other two ends supply the other phase of the RF voltage, each end again with one of the two DC potentials.

It is also possible to use more than two secondary windings: In general, n secondary windings can generate n DC potentials, each supplied with both phases of the RF voltage. By applying them to resistance layers, it is thus possible to generate n−1 independent voltage drops. The DC potentials can also be applied, however, across the individual diaphragms of RF-connected diaphragm systems. The DC potentials on which the RF is superimposed then lie across 2n outputs of the transformer.

For the additional superimposition of a positive DC voltage on a first phase of the RF voltage and a negative DC voltage on the second phase, it is possible to use secondary windings which are divided in the middle, making it possible to supply the DC voltages for the two phases to the two half-windings separately.

The transformer can be an air-core transformer or can also have a magnetic core, for instance a ferrite core.

If the DC voltages are not too high, several secondary windings can be wound as twisted or braided litz systems; they then have precisely the same coupling to the primary winding. To generate a large number of different DC potentials which can also be changed dynamically, for example for ring systems with travelling fields, it is possible to use flexible foils with printed conductors. The flexible printed conductors can be simply wound one on top of the other.

The DC voltages fed in by this means are easy to vary, for example to temporally change them or switch them quickly. DC voltage pulses are transported to the ends of the windings in the transformer very quickly and without the delays usually associated with chokes because the magnetic fields of the DC voltage pulse currents in the two halves of the windings compensate each other because of the reversed direction of the current.

### BRIEF DESCRIPTION OF THE DRAWINGS

The above and further advantages of the invention may be better understood by referring to the following description in conjunction with the accompanying drawings in which:

FIG. 1 depicts the voltage supply of a so-called “ion funnel” (7) which drives ions through a DC potential gradient across the chains of resistors (8) and (9) to a small output hole, the ions being kept away from the ring diaphragms by the changing phases of the RF voltage across the ring diaphragms which build up a repelling pseudopotential.

FIG. 2 shows a schematic diagram of the voltage supply for a quadrupole electrode system with isolated resistive surface layers, two electrodes positioned opposite each other being shown here. The primary coil (40) produces an RF voltage in the secondary winding (42, 45), the hot end (42) of the secondary winding supplying the hyperbolic electrodes (50) and (51), the hot end (45) the two other (not visible) hyperbolic electrodes. The center points of the secondary windings (44, 47) and (43, 46) are fed by two adjustable DC power supplies (48) and (49) respectively connected in parallel across each of them and the secondary winding (42, 45), the hot ends (42) and (44) generating a voltage drop on the resistance layers (52) and (53). At position (54) the resistance layers (52) and (53) are connected to the hyperbolic electrodes (50) and (51) underneath so that it is possible to set two independent voltage drops in the sections (55, 54) and (54, 56).

FIG. 3 shows schematically the supply of a quadrupole filter with adjacent resistive electrodes (30) and (31), with an inlet ramp extending from the input of the quadrupole filter (layer terminals 34, 36) to the through-hole plating (38), and an outlet ramp from the through-hole plating (39) to the end of the quadrupole filter (layer terminals 35, 37). The supply requires three secondary windings divided in the middle (11, 12), (13, 14) and (15, 16), but no chokes or resistors.

### DETAILED DESCRIPTION

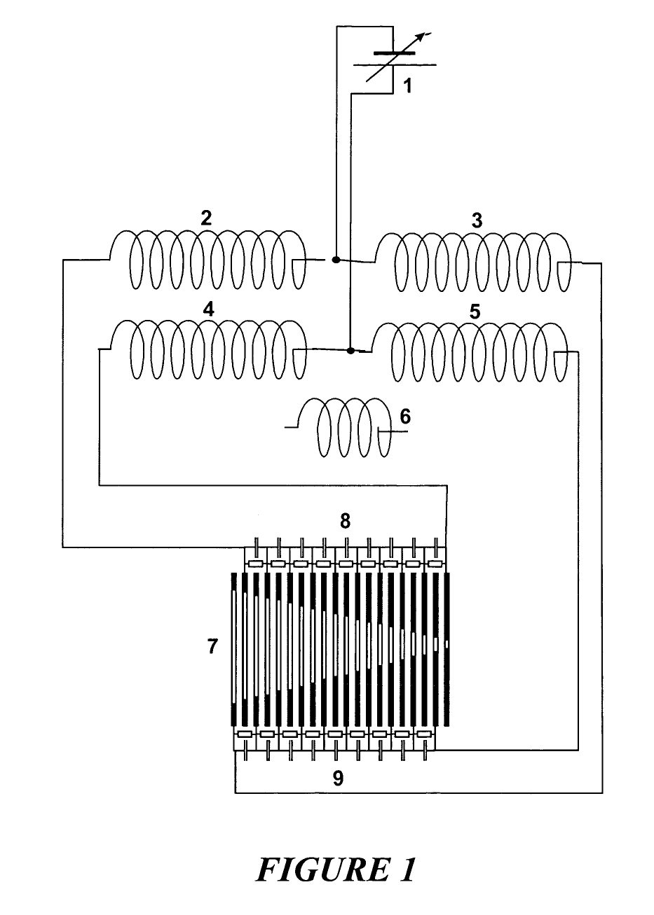

A first embodiment of a very simple kind relates to the supply of a so-called “ion funnel” and is reproduced in FIG. 1. An ion funnel (7) comprises a number of ring diaphragms with ever-decreasing internal diameters so that a funnel is created on the inside. Ions are blown into the large aperture, for example through a capillary, which admits ions from an ion source situated outside the vacuum together with the ambient gas. The ion funnel inside a first vacuum chamber system is intended to carry the ambient gas away to a pump, filtering the ions and guiding them through the small aperture of the funnel into the next vacuum chamber. To facilitate this, a forward drive of the ions to the small aperture must be set up; this is provided by a DC potential gradient, which is generated by the voltage source (1) across the chains of resistors (8) and (9). The ions are kept within the funnel formed by the ring diaphragms by pseudopotentials in the interior of the funnel, said pseudopotentials being generated by an RF voltage whose phases lie alternately on the ring diaphragms. The RF voltage is generated here in two separate secondary windings (2, 3) and (4, 5) via a primary winding (6) of a transformer. The DC voltage for the desired potential gradient is generated by the variable voltage generator (1) and fed in at the center taps between the two secondary coils (2, 3) and (4, 5). The hot ends of the half-windings (2) and (4) are connected to the chain of resistors (8) which generates the potential gradient, the RF voltage being distributed to all odd-numbered apertured diaphragms in the same way via the parallel chain of capacitors. Analogous to this, the hot ends of the half-windings (3) and (5) are applied across the chain of resistors (9) connected to the even-numbered diaphragms; the other phase of the RF is imposed onto this potential gradient.

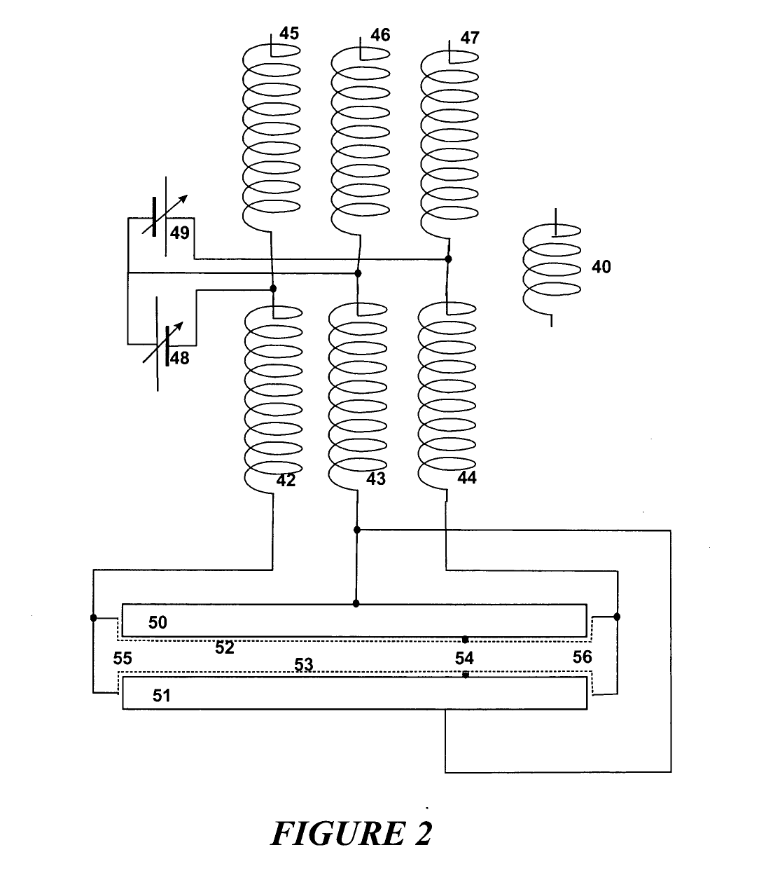

A second embodiment for the voltage supply of a collision cell is shown schematically in FIG. 2. The collision cell consists of four hyperbolic electrodes, of which only the two electrodes positioned opposite each other (50) and (51) are visible in the figure. The electrodes are coated over nonconducting layers with resistance layers (52) and (53) which are connected at one point (54) with the electrodes (50) and (51) below so as to be electrically conducting. Two independently variable potential gradients are intended to be generated on the partial sections (55-54) and (54-56) of the collision cell.

The voltage is supplied by a transformer carrying a primary winding (40) and three secondary windings (42-45), (43-46) and (44-47), each with a center tap. The secondary windings are (unlike the schematic drawing, which uses the form usually used in electrical engineering) all wound on the same core with the same coupling to the primary winding (40). This can be an air-core transformer or a transformer with magnetic core, for example a ferrite core. The hot ends of the secondary winding (43-46) supply the four hyberbolic electrodes cores in the normal way, electrodes facing each other (50, 51) each being supplied with the same phase (43); the two other electrodes and their connections to phase (46) are not shown here. Two independently variable DC voltages (48) and (49) are fed in between the center taps of the other two secondary windings (42-45) and (44-47) and the aforementioned secondary winding (43-46). The ends (42) and (44) of these windings are each connected with the ends of both resistive chromium layers (52, 53) in such a way that a DC current flows through the windings and the resistive chromium layer, generating a voltage drop along the chromium layers, but at the same time the RF voltage is also applied across both ends of the chromium layers. At point (54) the resistance layers (52, 53) are connected through the insulating layer to the hyperbolic electrodes (50, 51) below, making it possible to generate two independent voltage drops in the sections (55-54) and (54-56) of the quadrupole system. The RF voltage of these supply leads does not have to supply the entirety of the chromium layers (52, 53) with RF voltage in this case, since the RF voltage forms a capacitive coupling mainly through the insulating layer of the hyperbolic electrodes (50, 51). This simple circuit avoids the use of capacitors, resistors and chokes to connect the hot side of the transformer windings. It is possible to use a litz wire made of three braided strands for the three windings, for example.

Since the electrically conductive resistance surface layers (52) and (53), each insulated from the hyperbolic electrodes (50) and (51), are connected at point (54) with the hyperbolic electrodes (50) and (51) below, it is possible to form the voltage drop in the two partial sections (55-54) and (54-56) separately by setting the voltages (48) and (49). By using four or more secondary windings in each case, it would also be possible to form three or more partial sections of the voltage drop. This makes it possible to produce, for example, different shapes of collection basins for ions inside an electrode system which can be emptied by changing the DC voltages.

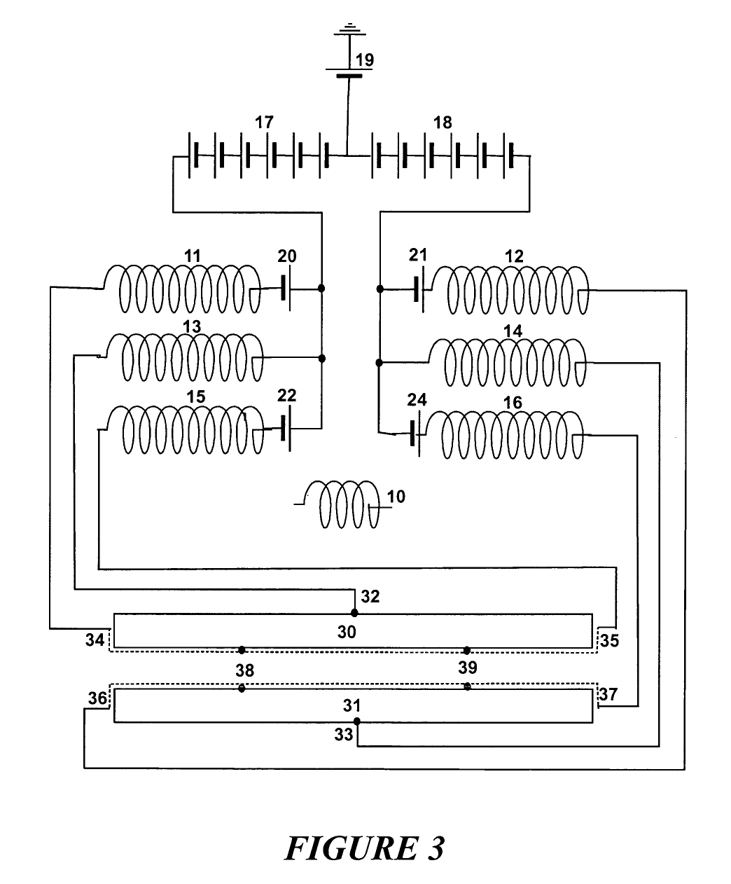

A third embodiment of this invention is reproduced in FIG. 3. This circuit supplies a precision mass filter, but one which has an inlet ramp for better acceptance of the injected ions and an outlet ramp for generating a better ion beam for further manipulation of the ions. In contrast to earlier mass filters, this precision mass filter can be operated at a high damping gas pressure; indeed it only presents its advantageous performance at a moderate damping gas pressure.

FIG. 3 shows the supply of two parallel electrodes (30) and (31) of this precision quadrupole filter with resistance layers, insulated from the electrodes (30) and
(31) by an insulating intermediate layer, via three secondary windings (11+12), (13+14) and (15+16) each divided in the middle. The two half-windings (13) and (14) supply the electrodes (30) and (31) via connection point (32) and (33), the other half-windings supply the resistance layer on the electrodes. The DC voltages which are intended to be superimposed on the two phases of the RF voltage originate from the two DC generators (17) and (18). The DC voltage (20) is responsible for the ramp-like attenuation of this DC voltage of one polarity in the injection region between the end of electrode (34) and the through-hole plating (38); the DC voltage (21) serves to attenuate the other polarity. The two DC voltages (22) and (24) supply the outlet ramp between the through-hole plating (39) and the end (35) and (37) of the resistance layer. The supply requires three split windings of the transformer but no chokes or additional resistors or capacitors to separate the RF voltage from the DC generators. The potential in the axis of the electrode system can also be changed; this is performed by the voltage generator (19). The RF voltage is transmitted from the primary winding (10).

The specialist in this field will recognize many additional applications for RF electrode systems which can be improved by application of this invention. These include embodiments of collision cells with rod systems, or with a row of apertured diaphragms, or with a double helix, for example. These also include ion storage cells for the temporary storage of ions with rapid emptying possibility, as well as traveling field arrays comprising a row of apertured diaphragms to which numerous individual potentials, including continuous potential hills, that can be supplied via numerous secondary windings, as described in U.S. Pat. No. 6,693,276.

This particular variant of the invention for coaxially arranged ring diaphragm systems, in which the stored ions are driven in one direction by travelling waves, can use one winding for every two ring diaphragms for maximum flexibility of the operating modes. Since the required RF voltages are not extremely high, it is possible to use wound flexible printed conductors in this case for the secondary windings.

In the normal cases of a small number of potentials, the secondary windings can be wound individually, or they can be wound together as a twisted or braided strand with several litz wires or wires insulated from each other. The transformers used can be air-core transformers on a ceramic tube, for example, or also magnetic core transformers with a ferrite core.

With knowledge of this invention, it is easily possible for the specialist in this field to solve other tasks involving the supply of superimposed RF and DC voltages to ion-optical electrode systems.

1. Wiring of an ion-optical RF electrode system with at least two DC potentials upon which both phases of the RF voltage are superimposed separately, wherein
the DC potentials are supplied by means of center taps between at least two separate secondary windings of an RF transformer generating the RF voltage for the electrodes.

2. Wiring of an ion-optical RF electrode system according to claim 1, wherein the at least two secondary windings are each divided in the middle in order to be able to superimpose a further DC potential on each of the two phases of the RF voltage separately.

3. Wiring of an ion-optical RF electrode system according to claim 1, wherein the at least two DC potentials generate at least one voltage drop across chains of resistors or resistance layers resulting in a desired DC potential gradient in the RF electrode system.

4. Transformer for the wiring of an ion-optical RF electrode system comprising
a primary winding connected to an RF generator, and
at least two secondary windings with center taps, said center taps being connected to DC generators.

5. Transformer according to claim 4, wherein the secondary windings are divided in the middle, the at least four half-windings being connected to at least four DC generators at the middle.

6. Transformer according to claim 4, wherein the at least two secondary windings are wound out of at least two twisted or braided wires or litz wires.

7. Transformer according to claim 4, wherein the at least two secondary windings consisting of printed conductors are wound on a flexible foil.
